(19) United States
(12) Patent Application Publication
(10) Pub. No.: US 2018/0322209 A1
(43) Pub. Date: Nov. 8, 2018

(54) METHOD, APPARATUS, COMPUTING DEVICE, AND MACHINE-READABLE STORAGE MEDIUM FOR RECOMMENDING ACTIVITY INFORMATION

(71) Applicant: GUANGZHOU SHENMA MOBILE INFORMATION TECHNOLOGY CO., LTD., Guangzhou (CN)

(72) Inventors: Zhiting JIN, Guangzhou (CN); Qiuhui LI, Guangzhou (CN); Ying ZHENG, Guangzhou (CN); Zhiyu ZHANG, Guangzhou (CN)

(21) Appl. No.: 15/771,900

(22) PCT Filed: Oct. 11, 2016
(86) PCT No.: PCT/CN2016/101749

§ 371 Date: Apr. 27, 2018

(30) Foreign Application Priority Data
Oct. 29, 2015 (CN) 201510725170.0

(51) Int. Cl. G06F 17/30

(52) U.S. Cl. CPC G06F 17/30867

(57) ABSTRACT

The present disclosure provides a method, a computing device, and a machine-readable storage medium for recommending activity information. The method includes selecting an activity information item with a highest user preference value from an activity list according to a historical click record of a user for browsing webpage information, webpage information browsing including news message browsing, and sending the selected activity information item and webpage information correlatively to the user.

### CROSS REFERENCE TO RELATED APPLICATIONS

This application is a national phase of PCT application No. PCT/CN2016/101749, filed on Oct. 11, 2016, which claims the priority of Chinese Patent Application No. CN201510725170.0, filed on Oct. 29, 2015, the entire content of which is incorporated herein by reference.

### FIELD OF THE DISCLOSURE

The present disclosure generally relates to the field of internet communication and, more particularly, relates to methods, apparatuses, computing devices, and machine-readable storage media for recommending activity information.

### BACKGROUND

Reading the news has become a lifestyle of users. Every day, a large number of users login news servers to read the news. In order to fully develop the related user market, servers usually recommend activity information items to the users, and thus guide the users to participate in the activity and create business value.

Currently, a method for recommending activity information is provided. The method includes: when detecting that a client terminal logs in to a server, the server acquires a preset activity information item, and recommends the acquired activity information item to the client terminal by sending a short message to the client terminal by a reminder message. The client terminal notifies the user of receiving the short message. When the user clicks on the short message, the activity information item in the short message is displayed.

However, when using a short message to recommend activity information, the recommended activity information item and the news cannot be displayed simultaneously. In addition, the recommended activity information item is not necessarily an activity information item that the user is interested in. Therefore, the possibility for the user to view the activity information item may be low, and thus user's participation in the activity according to the activity information item may be reduced.

### BRIEF SUMMARY OF THE DISCLOSURE

In view of the above issue, the objective of the present disclosure is to provide a method and an apparatus for recommending activity information. An activity information item with the highest user preference value may be selected, and the activity information item may be inserted into a news message list. As such, the recommended activity information item may be an activity information item that the user is interested in; in the meantime, the activity information item can be displayed simultaneously with the news, improving user's participation in the activity according to the activity information item.

A first aspect of the present disclosure provides a method for recommending activity information. The method includes:

selecting an activity information item with a highest user preference value from an activity list according to a historical click record of a user for browsing webpage information, webpage information browsing including news message browsing; and

sending the selected activity information item and webpage information correlatively to the user.

In combination with the first aspect, the present disclosure provides a first possible implementation for the disclosed method consistent with some embodiments of the present invention. According to the first possible implementation, selecting the activity information item with the highest user preference value from the activity list according to the historical click record of the user for browsing webpage information includes:

determining type labels corresponding to each activity information item in the activity list;

according to the historical click record of the user and the type labels corresponding to each activity information item, calculating the user preference value for each activity information item respectively; and

selecting the activity information item with the highest user preference value from the activity information items.

In combination with the first possible implementation of the first aspect, the present disclosure provides a second possible implementation for the disclosed method consistent with some embodiments of the present invention. According to the second possible implementation, the historical click record includes type labels corresponding to the news messages clicked by the user in a past preset time range and a number of clicks on each type label.

According to the historical click record of the user and the type labels corresponding to each activity information item, calculating the user preference value for each activity information item respectively includes:

acquiring the number of the clicks on each type label corresponding to the activity information item in the historical click record; and

counting the number of the clicks on each type label corresponding to the activity information item for a sum value, and assigning the counted sum value as the user preference value of the activity information item.

In combination with the first aspect, the present disclosure provides a third possible implementation for the disclosed method consistent with some embodiments of the present invention. According to the third possible implementation, sending the selected activity information item and the webpage information correlatively to the user includes:

inserting the selected activity information item into a preset position of a news message list requested by the user; or

determining, from the news message list, a news message having a highest similarity value with the selected activity information item, and inserting the activity information item into a position of the determined news message.

In combination with the third possible implementation, the present disclosure provides a fourth possible implementation for the disclosed method consistent with some embodiments of the present invention. According to the fourth possible implementation, determining, from the news message list, the news message having the highest similarity value with the selected activity information item includes:

determining type labels corresponding to each news message in the news message list respectively and determining the type labels corresponding to the selected activity information item;

determining, among the type labels corresponding to each news message respectively, a number of type labels that are same as corresponding to the selected activity information item;

using the number of the type labels corresponding to each news message that are the same as corresponding to the selected activity information item respectively as a similarity value between each news message and the activity information item;

selecting the news message with the highest similarity value from the news messages.

In combination with the first aspect, the present disclosure provides a fifth possible implementation for the disclosed method consistent with some embodiments of the present invention. According to the fifth possible implementation, the method also includes:

in response to a browsing request from a user for a news message, updating the historical click record of the user,

updating the historical click record of the user including:

determining type labels corresponding to the requested news message;

querying whether the historical click record includes any type label corresponding to the requested news message;

when the historical click record includes a type label corresponding to the requested news message, adding one to a number of clicks on the type label corresponding to the news message in the historical click record;

when the historical click record does not include a type label corresponding to the requested news message, adding the type label corresponding to the requested news message into the historical click record, and assigning the number of the clicks on the type label as one.

In combination with the first aspect, the present disclosure provides a sixth passible implementation for the disclosed method consistent with some embodiments of the present invention. According to the sixth possible implementation, the method also includes:

acquiring a centralized browsing time range corresponding to the user, and when a current time is determined to be in the centralized browsing time range, performing an operation for selecting the activity information item with the highest user preference value from the activity list.

In combination with the sixth possible implementation of the first aspect, the present disclosure provides a seventh possible implementation for the disclosed method consistent with some embodiments of the present invention. According to the seventh possible implementation, acquiring the centralized browsing time range corresponding to the user includes:

recording a time of receiving a browsing request from the user for the webpage information as a browsing time record of the user, and determining the centralized browsing time range of the user according to the browsing time record of the user.

In combination with the first aspect, the present disclosure provides an eighth possible implementation for the disclosed method consistent with some embodiments of the present invention. According to the eighth possible implementation, selecting the activity information item with the highest user preference value from the activity list further includes:

acquiring an issued activity queue corresponding to the user, and

selecting, from the activity list, the activity information item having a similarity value with each activity information item in the issued activity queue less than or equal to a preset threshold value and having the highest user preference value.

In combination with the eighth possible implementation of the first aspect, the present disclosure provides a ninth possible implementation for the disclosed method consistent with some embodiments of the present invention. According to the ninth possible implementation, selecting, from the activity list, the activity information item having the similarity value with each activity information item in the issued activity queue less than or equal to the preset threshold value and having the highest user preference value includes:

acquiring, among the type labels corresponding to each activity information item in the issued activity queue, a number of the type labels that are same type labels corresponding to the selected activity information item in the activity list as a similarity value.

In combination with the ninth possible implementation of the first aspect, the present disclosure provides a tenth possible implementation for the disclosed method consistent with some embodiments of the present invention. According to the tenth possible implementation, the method also includes:

in response to sending the selected activity information item and the webpage information correlatively to the user, adding an issued time of the activity information item and the activity information item into the issued activity queue corresponding to the user.

In combination with the tenth possible implementation of the first aspect, the present disclosure provides an eleventh possible implementation for the disclosed method consistent with some embodiments of the present invention. According to the eleventh possible implementation, prior to adding the issued time and the activity information item into the issued activity queue corresponding to the user, the method also includes:

determining whether the issued activity queue is full, when the issued activity queue is not full, performing an operation to add the issued time and the activity information item into the issued activity queue corresponding to the user;

when the issued activity queue is determined to be full, from the issued activity queue, determining an activity information item with a largest time difference between the issued time and the current time, removing the determined activity information item from the issued activity queue, and performing the operation to add the issued time and the activity information item into the issued activity queue corresponding to the user.

In combination with the first aspect, the present disclosure provides a twelfth possible implementation for the disclosed method consistent with some embodiments of the present invention. According to the twelfth possible implementation, the method also includes:

performing a semantic analysis on each activity information item included in the activity list to extract a preset number of keywords from each activity information item, and making the keywords corresponding to each activity information item as type labels corresponding to the activity information item.

In combination with the twelfth possible implementation of the first aspect, the present disclosure provides a thirteenth possible implementation for the disclosed method consistent with some embodiments of the present invention. According to the thirteenth possible implementation, making the keywords corresponding to each activity information item as the type labels corresponding to the activity information item also includes:

forming a label collection using the type labels corresponding to each activity information item; and

performing a semantic analysis on a news message to extract a plurality of keywords from the news message, querying whether the label collection includes the extracted keywords, and when the label collection includes the extracted keywords, making the keywords included in the label collection as type labels corresponding to the news message.

A second aspect of the present disclosure provides an apparatus for recommending activity information. The apparatus includes:

a selection module, configured to select an activity information item with a highest user preference value from an activity list according to a historical click record of a user for browsing webpage information, webpage information browsing including news message browsing; and

an insertion and sending module, configured to send the selected activity information item and webpage information correlatively to the user.

In combination with the second aspect, the present disclosure provides a first possible implementation for the disclosed apparatus consistent with some embodiments of the present invention. According to the first possible implementation, the selection module includes:

a first determination unit, configured to determine type labels corresponding to each activity information item included in the activity list;

a calculation unit, configured to, according to the historical click record of the user and the type labels corresponding to each activity information item, calculate the user preference value for each activity information item respectively; and

a selection unit, configured to select the activity information item with the highest user preference value from the activity information items.

In combination with the first possible implementation of the second aspect, the present disclosure provides a second possible implementation for the disclosed apparatus consistent with some embodiments of the present invention. According to the second possible implementation, the historical click record includes the type labels corresponding to the news messages clicked by the user in a past preset time range and the number of the clicks on each type label; and the calculation unit includes:

an acquisition sub-unit, configured to acquire the number of the clicks on each type label corresponding to the activity information item in the historical click record; and

a statistic sub-unit, configured to count the number of the clicks on each type label corresponding to the activity information item for a sum value, and assign the counted sum value as the user preference value of the activity information item.

In combination with the second aspect, the present disclosure provides a third possible implementation for the disclosed apparatus consistent with some embodiments of the present invention. According to the third possible implementation, the insertion and sending module includes:

a first insertion unit, configured to insert the selected activity information item into a preset position of the news message list requested by the user; or

a second insertion unit, configured to determine, from the news message list, a news message having a highest similarity value with the selected activity information item, and insert the activity information item into a position of the determined news message.

In combination with the third possible implementation of the second aspect, the present disclosure provides a fourth possible implementation for the disclosed apparatus consistent with some embodiments of the present invention. According to the fourth possible implementation, the second insertion unit includes:

a determination sub-unit, configured to determine type labels corresponding to each news message in the news message list respectively and determine the type labels corresponding to the selected activity information item; determine, among the type labels corresponding to each news message respectively, a number of type labels that are same as corresponding to the selected activity information item; and use the number of the type labels corresponding to each news message that are the same as corresponding to the selected activity information item respectively as a similarity value between each news message and the activity information item; and

a selection sub-unit, configured to select the news message with the highest similarity value from the news messages.

In combination with the second aspect, the present disclosure provides a fifth possible implementation for the disclosed apparatus consistent with some embodiments of the present invention. According to the fifth possible implementation, the apparatus also includes:

a click-number modification module, configured to in response to a browsing request from a user for a news message, update the historical click record of the user.

the click-number modification module is further configured to determine the type labels corresponding to the requested news message; query whether the historical click record includes any type label corresponding to the requested news message; when the historical click record includes a type label corresponding to the requested news message, add one to a number of clicks on the type label corresponding to the news message in the historical click record; and when the historical click record does not includes a type label corresponding to the requested news message, add the type label corresponding to the requested news message into the historical click record, and assign the number of the clicks on the type label as one.

In combination with the second aspect, the present disclosure provides a sixth possible implementation for the disclosed apparatus consistent with some embodiments of the present invention. According to the sixth possible implementation, the apparatus also includes:

a recommendation-time determination module, configured to acquire a centralized browsing time range corresponding to the user, and when a current time is determined to be in the centralized browsing time range, control the selection module to perform an operation for selecting the activity information item with the highest user preference value from the activity list.

In combination with the sixth possible implementation of the second aspect, the present disclosure provides a seventh possible implementation for the disclosed apparatus consistent with some embodiments of the present invention. According to the seventh possible implementation, the apparatus also includes:

a memory module, configured to record a time of receiving a browsing request from the user for the webpage information as a browsing time record of the user, and determine the centralized browsing time range of the user according to the browsing time record of the user.

In combination with the second aspect, the present disclosure provides an eighth possible implementation for the disclosed apparatus consistent with some embodiments of the present invention. According to the eighth possible implementation, the apparatus also includes:

a duplicated activity information removal module, configured to select, from the activity list, the activity information item having a similarity value with each activity information item in the issued activity queue less than or equal to a preset threshold value and having the highest user preference value.

In combination with the eighth possible implementation of the second aspect, the present disclosure provides a ninth possible implementation for the disclosed apparatus consistent with some embodiments of the present invention. According to the ninth possible implementation, the duplicated activity information removal module includes:

an acquisition unit, configured to acquire, among the type labels corresponding to each activity information item in the issued activity queue, a number of the type labels that are same type labels corresponding to the selected activity information item in the activity list as a similarity value.

In combination with the ninth possible implementation of the second aspect, the present disclosure provides a tenth possible implementation for the disclosed apparatus consistent with some embodiments of the present invention. According to the tenth possible implementation, the apparatus also includes:

an add module, configured to in response to sending the selected activity information item and the webpage information correlatively to the user, add an issued time of the activity information item and the activity information item into the issued activity queue corresponding to the user.

In combination with the tenth possible implementation of the first aspect, the present disclosure provides an eleventh possible implementation for the disclosed apparatus consistent with some embodiments of the present invention. According to the eleventh possible implementation, the apparatus also includes:

a determination module, configured to determine whether the issued activity queue is full, when the issued activity queue is not full, the operation to add the issued time and the activity information item into the issued activity queue corresponding to the user is performed; when the issued activity queue is determined to be full, from the issued activity queue, an activity information item with a largest time difference between the issued time and the current time is determined, the determined activity information item is removed from the issued activity queue, and the operation to add the issued time and the activity information item into the issued activity queue corresponding to the user is performed.

In combination with the second aspect, the present disclosure provides a twelfth possible implementation for the disclosed apparatus consistent with some embodiments of the present invention. According to the twelfth possible implementation, the apparatus also includes:

a type label determination module, configured to perform a semantic analysis on each activity information item included in the activity list to extract a preset number of keywords from each activity information item, and make the keywords corresponding to each activity information item as the type labels corresponding to the activity information item.

In combination with the twelfth possible implementation of the second aspect, the present disclosure provides a thirteenth possible implementation for the disclosed apparatus consistent with some embodiments of the present invention. According to the thirteenth possible implementation, the type label determination module is also used to form a label collection using the type labels corresponding to each activity information item, perform a semantic analysis on the news message to extract a plurality of keywords from the news message, query whether the label collection includes the extracted keywords, and when the label collection includes the extracted keywords, make the keywords included in the label collection as type labels corresponding to the news message.

A third aspect of the present disclosure provides a computing device, the computing device includes: a receiver, a transmitter, and a processor;

the receiver is configured receive a browsing request for webpage information sent from a client terminal, the browsing request for the webpage information including a user identification (ID) and a webpage address, the webpage information including news messages;

the processor is configured to acquire a news message list according to the webpage address, and acquire a historical click record of the user according to the user ID; select an activity information item with a highest user preference value from an activity list according to the historical click record; and insert the selected activity information item into the news message list;

the transmitter is configured to send the news message list to the client terminal.

A fourth aspect of the present disclosure provides another computing device. The computing device includes:

a network interface, the network interface allowing the computing device to communicate a browsing request from a user for webpage information through one or more networks;

one or more processors, connected with the network interface, the one or more processors configured to execute following operations:
selecting an activity information item with a highest user preference value from the activity list according to a historical click record of the user for browsing webpage information, wherein webpage information browsing includes news message browsing; and
sending the selected activity information item and the webpage information correlatively to the user; and

a display, connected to the one or more processors, and configured to display the activity information item and the webpage information to the user.

A fifth aspect of the present disclosure provides a non-transitory machine-readable storage medium. The machine-readable storage medium may contain pre-stored executable code. When the executable code is executed by the one or more processors, the one or more processors implement the method according to the first aspect of the present disclosure.

According to the methods, the apparatuses and the computing devices provided by various embodiments of the present invention, an activity information item with the highest user preference value is selected from an activity list according to the historical click record; the selected activity information item is inserted into a news message list, and the news message list is sent to the client terminal. According to the present disclosure, the activity information item with the highest user preference value is selected, and the selected activity information item is inserted into the news message list. Therefore, the recommended activity information item is the information that the user is interested in, and the activity information item can also be displayed together with the news messages. When the user browses the news message list, the activity information item can also be viewed. Therefore, user's participation in the activity corresponding to the activity information item may be improved.

In order to make the above objectives, features and advantages of the present disclosure more comprehensible and easy to understand, various embodiments are described below with reference to the accompanying drawings.

### BRIEF DESCRIPTION OF THE DRAWINGS

In order to describe the technical schemes in the embodiments of the present disclosure more clearly, the following briefly introduces the accompanying drawings required for describing the embodiments. It should be understood that the following drawings merely illustrate some embodiments of the present invention and therefore, shall not be regarded as to limit the scope of the present invention. For those skilled in the art, other related drawings may also be obtained based on these drawings without any creative work.

FIG. 1A illustrates a flowchart of an exemplary method for recommending activity information consistent with various embodiments of the present disclosure;

FIG. 1B illustrates a schematic diagram of an exemplary news page consistent with various embodiments of the present disclosure;

FIG. 2 illustrates a schematic structural diagram of an exemplary apparatus for recommending activity information consistent with various embodiments of the present disclosure; and

FIG. 3 illustrates a schematic structural diagram of an exemplary computing device consistent with various embodiments of the present disclosure.

### DETAILED DESCRIPTION

In the following, the technical schemes in the embodiments of the present disclosure are clearly and completely described with reference to the accompanying drawings. Apparently, the described embodiments are merely some but not all of the embodiments of the present invention. The components of the embodiments of the present disclosure, generally described and illustrated in the figures herein, may be arranged and designed in a wide variety of different configurations. Accordingly, the following detailed description of the embodiments provided in the accompanying drawings is not intended to limit the scope of the invention, but merely to illustrate selected embodiments of the invention. All other embodiments obtained by those skilled in the art based on the embodiments of the present disclosure without creative efforts shall fall within the protection scope of the present invention.

Considering that in related techniques, when an activity information item is recommended through a short message, the activity information item and the news cannot be displayed simultaneously, and the recommended activity information item is not necessarily the activity information item that the user is interested in. Therefore, the possibility of the user viewing the activity information item is very low, and thus user's participation in the activity corresponding to the activity information item may be reduced. In view of this, the present disclosure provides a method, an apparatus and a computing device for recommending activity information. In the following, various embodiments consistent with the present disclosure will be provided for further illustration.

### Embodiment 1

The present disclosure provides a method for recommending activity information. The main executive part of the disclosed method is a computing device, e.g. a client browser or a corresponding intermediate server. For illustrative purposes, in the following, an intermediate server will be provided as an example for description, but those of ordinary skill in the art will understand that the main executive part of the disclosed method is not limited to a server, but may be applied to any computing device that can push information to a user according to a webpage browsing request of the user.

When a user logs in a server from a terminal to request to browse webpage information including news messages, the server may, through a method consistent with some embodiments of the present disclosure, recommend an activity information item, such as prize information, activity rules, etc. to the user.

The server may preset an activity list, and the activity list may include a plurality of activity information items. The server may perform a semantic analysis on each activity information item included in the activity list to extract a preset number of keywords from the activity information item, and making the extracted keywords corresponding to each activity information item as type labels corresponding to the activity information item.

In order to make the server's operation for determining the type labels corresponding to the activity information item easily understood, in the following, an example will be provided for illustration. In one embodiment, the preset number is assumed to be 2, and the activity information item is assumed to be “Polar Motor Racing Sports Invites You to Participate”. The server performs a semantic analysis on the activity information item to extract two keywords from the activity information item. Assuming that the two extracted keywords are “Motor Racing” and “Sports”, respectively, the two keywords “Motor Racing” and “Sports” are thus identified as the type labels corresponding to the activity information item.

After the server determines the type labels corresponding to each activity information item in the activity list using the method described above, the server may also form a label collection using the type labels corresponding to each activity information item. When the type labels corresponding to each activity information item are determined using the method described above, different activity information items may have a same type label. Therefore, after the label collection described above is formed, for the repeated type labels of the label collection, only one may be kept in the label collection, and the rest may be deleted.

The server may also perform a semantic analysis on a news message to extract a plurality of keywords from the news message, query whether the label collection described above includes the extracted keywords, and when the label collection includes the extracted keywords, make the keywords included in the label collection as the type labels corresponding to the news message. For each news message stored in the server, the type labels corresponding to each news message are respectively determined using the method described above.

For example, the news message is assumed to be “Zhangsan Won the Asian Motor Racing Sports Championship”, and the collection of labels is assumed to be {racing, sports, books}. The server performs a semantic analysis on the news message and the keywords extracted from the news message are “Motor Racing”, “Sports” and “Zhangsan”. Further, each extracted keyword that also appears in the label collection may be used as a type label corresponding to the news message. That is, the keywords “Motor Racing” and “Sports” may be determined as the type labels corresponding to the news message.

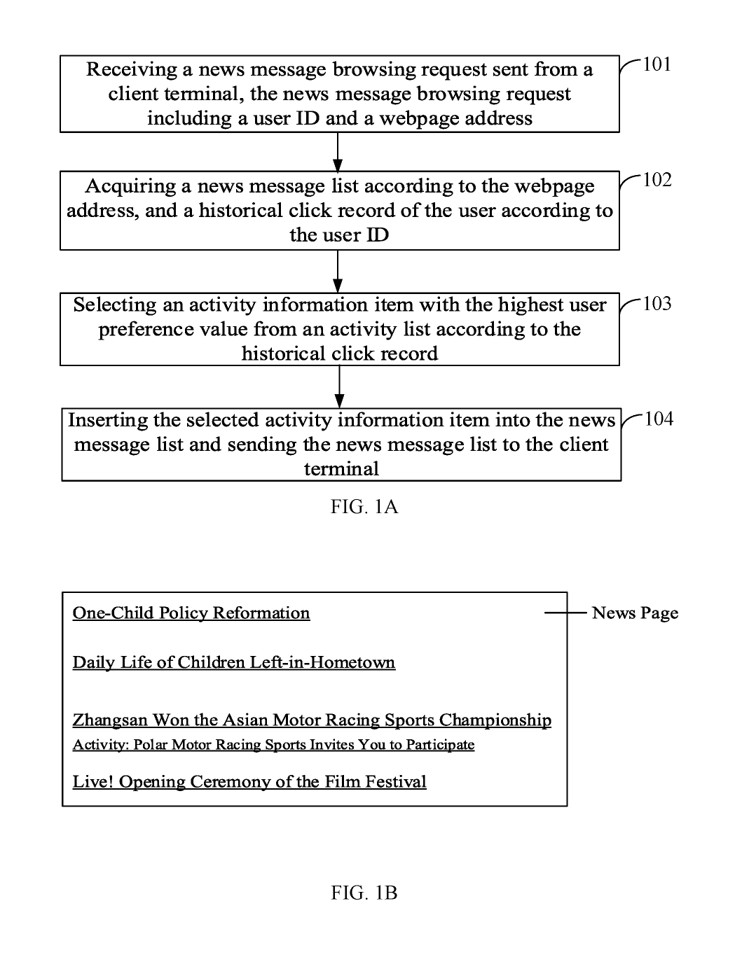

After the server determines the type labels corresponding to each activity information item in the activity list using the method described above, and determines the type labels corresponding to each news message, referring to FIG. 1 A, an activity information item may be recommended to the user through the following operations of Steps 101-104.

In Step 101, a news message browsing request sent from a client terminal may be received. The news message browsing request may include a user ID and a webpage address.

When a user needs to browse a news message through a terminal, the user may click the navigation link of the news message displayed by the terminal to trigger the browsing instruction. When the terminal detects the browsing instruction triggered by the navigation link of the news message, the terminal may obtain the user ID and the webpage address corresponding to the navigation link of the news message, and send a news message browsing request to the server. In addition, the news message browsing request may also carry the acquired user ID and the webpage address. The server may receive the news message browsing request sent by the client terminal. Moreover, the user ID may be an account of the user.

In Step 102, a news message list may be acquired according to the webpage address, and a historical click record of the user may be acquired according to the user ID.

The server may store the corresponding relation between webpage addresses, which correspond to the navigation links of the news messages, and news message lists. The news message list may include a plurality of news messages. After receiving the news message browsing request sent by the terminal, the server may, according to the webpage address included in the news message browsing request, acquire the corresponding news message list from the stored corresponding relation between the webpage addresses and the news message lists.

In addition, the server may also store the corresponding relation between the user IDs and the historical click records. The historical click record of a user may include the type labels corresponding to the news messages that the user clicked within a preset time range and the number of the clicks on each type label. For example, the historical click record may record that the type labels corresponding to the news messages clicked by the user in the past day are “Motor Racing” and “Sports”, the number of the clicks on the type label “Motor Racing” is 10, and the number of the clicks on the type label “Sports” is 20.

After receiving the news message browsing request sent by the terminal, the server may acquire the historical click record of the user from the corresponding relation between the user IDs and the historical click records according to the user ID included in the news message browsing request.

A user may read news messages at various time ranges during a day. However, the times at which the user reads the news messages may be centralized in a certain time range of a day. For example, a user may be accustomed to reading the news during a specific time range in the morning or in the evening. When an activity information item is recommended to the user during the time range in which the user usually reads the news, the user may be more likely to browse the activity information item and thus participate in the activity. Therefore, in one embodiment, the server may also determine a centralized browsing time range in which the user reads the news. A determination process may be as follows:

Each time after receiving a news message browsing request sent from a client terminal, the receiving time of the news message browsing request may be recorded in a browsing time record of the user; a centralized browsing time range of the user may be determined according to the browsing time record of the user, and the corresponding relation between the user ID and the centralized browsing time range of the user may be stored.

In one embodiment, the server may use a clustering algorithm such as a K-means algorithm, etc. to determine the centralized browsing time range of a user according to the browsing time record.

The browsing time record may record the time in each day that the user spends for browsing the news. A time unit with a preset time length may be preset in the server. The preset time length may be one hour or two hours. The server may acquire the time record of the user browsing the news in the previous day from the browsing time record of the user, divide the time record of the previous day into several sub-records based on the preset time unit, determine the number of the news message browsing requests that the server receives in each sub-record, and determine the time range corresponding to the sub-record having the largest number of received news message browsing requests as the centralized browsing time range of the user, or determine the time range corresponding to the sub-record having a number of received news message browsing requests greater than a preset number as the centralized browsing time range of the user.

In one embodiment, the server may also acquire the time record of a preset number of days in the past from the browsing time record of the user, and then determine the centralized browsing time range in each day based on the time record of the day included in the time record of the preset number of days according to the method described above. The server may further calculate an average value of the lower limit values of the determined centralized browsing time ranges in the preset number of days in the past and an average value of the upper limit values of the determined centralized browsing time ranges in the preset number of days in the past, and then determine the time range between the average value of the lower limit values and the average value of the upper limit values as the centralized browsing time range of the user.

After obtaining the centralized browsing time range of the user using the method described above, the corresponding relation between the user ID and the centralized browsing time ranges is stored. Prior to acquiring the historical click record of the user according to the user ID, the server may, based on the received user ID, acquire the centralized browsing time range corresponding to the user from the corresponding relation between the user IDs and the centralized browsing time ranges, and determine whether the current time is in the centralized browsing time range of the user. When it is determined that the current time is in the centralized browsing time range of the user, there is a high possibility that the user is currently browsing the news, such that the server may perform an operation to acquire the historical click record of the user according to the user ID. As such, when an activity information item is subsequently recommended to the user, the user browsing the activity information item and participating in the activity may be highly possible. When it is determined that the current time is not in the centralized browsing time range of the user, the user is less likely browsing the news at the moment. At this moment, when an activity information item is recommended to the user, the possibility of the user browsing the activity information and participating in the activity is very small. Therefore, at this moment, the acquired news message list may be directly sent to the client terminal without recommending any activity information item to the user.

After acquiring the historical click record of the user through the implementation of the above Step 102, the activity information item with the highest user preference value may be acquired through the implementation of the following Step 103 to improve the possibility of the user browsing the activity information item and participating in the activity.

In Step 103, according to the historical click record, an activity information item with the highest user preference value may be selected from an activity list.

The server may determine the type labels corresponding to each activity information item included in the activity list respectively; according to the historical click record and the type labels corresponding to each activity information item, calculate the user preference value for each activity information item respectively; select an activity information item with the highest user preference value from the activity information items.

The historical click record may include the type labels corresponding to the news messages clicked by the user in a preset time range and the number of the clicks on each type label. For each activity information item included in the activity list, the server may acquire the number of the clicks on each type label corresponding to the activity information item in the historical click record. The server may count the number of the clicks on each type label corresponding to the activity information item for a sum value, and assign the counted sum value as the user preference value of the activity information item. After the user preference value of each activity information item in the activity list is calculated using the method described above, the activity information item with the highest user preference value may be selected from the activity list.

In Step 104, the selected activity information item may be inserted into the news message list, and the news message list may be sent to the client terminal.

In one embodiment, a preset position for inserting the selected activity information item may be set in advance in the server. The preset position may be arranged on an upper side, a lower side, a left side, or a right side of the news message list, or may be the position of a news message that has a serial number in the news message list equal to a preset number. The server may insert the selected activity information item into the preset position of the news message list, and then send the news message list to the client terminal.

Moreover, because the news message list may include a plurality of news messages with different information contents, there may be a news message whose content is similar to the content of the selected activity information item. Since the user preference value of the selected activity information item is calculated based on the historical click record of the user in a past preset time range, the news message similar to the content of the selected activity information item may also be a news message that the user may be interested in. Therefore, the possibility for the user to browse the news message is very high. When the selected activity information item is inserted at a position of the similar news message, the user may be able to see the activity information item when browsing the news message, and may most likely participate in the activity corresponding to the activity information item.

Therefore, in one embodiment, the server may further determine the news message that has the highest similarity value with the selected activity information item from the news message list, and insert the activity information item at the position of the determined news message.

The server may determine the type labels corresponding to each news message in the news message list respectively and determine the type labels corresponding to the selected activity information item; determine, among the type labels corresponding to each news message respectively, a number of type labels that are same as corresponding to the selected activity information item; use the number of the type labels corresponding to each news message that are the same as corresponding to the selected activity information item respectively as a similarity value between each news message and the activity information item; select the news message with the highest similarity value from the news messages.

Using the method described above, the server may select the news message with the highest similarity value, and after inserting the activity information item with the highest user preference value into the position of the news message with the highest similarity value in the news message list, may send the news message list to the client terminal.

In one embodiment, although the type of news messages that the user prefers to read may change over time, for a short period of time such as two days or a week, the type of news messages that the user prefers may remain unchanged. Therefore, in a short period of time, a same or similar activity information item may be selected according to the historical click record of the user. For example, in two consecutive days, the selected activity information items with the highest user preference value may be a same activity information item. In this case, if the same activity information item is recommended to the user for two consecutive days, the probability of the user browsing the activity information item may be very low and the user experience may be poor.

In order to avoid the problem of recommending a same or similar activity information item, in one embodiment, the server may store the corresponding relation between user IDs and issued activity queues, and each issued activity queue may include activity information items that have been recommended to the user. Prior to inserting the selected activity information item into the news message list, the server may, according to the user ID of the user, acquire an issued activity queue corresponding to the user from the user IDs and the issued activity queues. The server may determine whether the issued activity queue includes an activity information item having a similarity value with the selected activity information item greater than a preset threshold value. When it is determined that no activity information item in the issued activity queue has a similarity value with the selected activity information item greater than the preset threshold value, the selected activity information item may be inserted into the news message list, and the news message list may then be sent to the client terminal. When it is determined that the issued activity queue includes an activity information item having a similarity value with the selected activity information item greater than the preset threshold value, the selected activity information item may be removed from the activity list, and then an activity information item with the highest user preference value may be selected from the revised activity list. The selection operation may be the same as the operation in Step 103, and the detail description is provided again herein. After the activity information item with the highest user preference value is selected out again, it may also be necessary to check whether the issued activity queue includes a same or similar activity information item, until the selected activity information item is not the same as or similar to any activity information item in the issued activity queue.

Determining whether the issued activity queue includes an activity information item having a similarity value with the selected activity information item greater than the preset threshold value includes the following:

The server may determine the type labels corresponding to the selected activity information item and also determine the type labels corresponding to each activity information item in the issued activity queue; acquire, among the type labels corresponding to each activity information item in the issued activity queue respectively, a number of type labels that are same as corresponding to the selected activity information item; use the number of the type labels corresponding to each activity information item that are the same as corresponding to the selected activity information item respectively as a similarity value between the activity information item and the activity information item; compare the similarity value corresponding to each activity information item to a preset threshold value to determine whether the issued activity queue includes an activity information item that has a similarity value greater than the preset threshold value.

After performing duplication removal on the selected activity information item using the method described above, the ultimately selected activity information item may be inserted into the news message list. The server may also use the current time as an issued time for the selected activity information item to add the issued time and the activity information item that is inserted into the news message list to the issued activity queue corresponding to the user.

When adding the issued time and the activity information item to the issued activity queue corresponding to the user, the server may need to first determine whether the issued activity queue corresponding to the user is full. When the issued activity queue is not full, the issued time and the activity information item may be directly added to the issued activity queue. When the issued activity queue is determined to be full, an overflow operation may be performed on the issued activity queue, and then the issued time and the selected activity information item may be added to the issued activity queue. Specifically, the process may include the following operations.

The server may determine whether the issued activity queue is full, and when the issued activity queue is not full, perform an operation to add the issued time and the activity information item into the issued activity queue corresponding to the user; when the issued activity queue is determined to be full, from the issued activity queue, determine an activity information item with a largest time difference between the issued time and the current time, remove the determined activity information item from the issued activity queue, and perform the operation to add the issued time and the activity information item into the issued activity queue corresponding to the user.

In one embodiment, the server may send a list of news messages including the inserted activity information item to the client terminal. The client terminal may receive the news message list, and may render and display the news page according to the new message list. The news page may include hyperlinks corresponding to a plurality of news messages and the activity information item recommended by the server. The news page displayed on the client terminal may be, for example, a webpage as shown in FIG. 1B. In FIG. 1B, a recommended activity information item “Polar Motor Racing Sports Invites You to Participate” may be inserted to the position of the news message “Zhangsan Won the Asian Motor Racing Sports Championship”. The recommended activity information item is similar to the content of the news message, and a user can see the recommended activity information item when browsing the news message.

A user may browse the news page. When the user needs to read the detail content of a news message, the user may click on the hyperlink corresponding to the news message. When the client terminal detects the browsing instruction triggered by the hyperlink, a news message browsing request for browsing the news message may be sent to the server. The news message browsing request may include the user ID and the news-message ID. The news-message ID may be the webpage address or the news title corresponding to the news message.

At this time, the server may receive the news message browsing request sent by the client terminal, acquire the historical click record of the user according to the user ID, and determine type labels corresponding to the requested news message according to the news-message ID; query whether the historical click record includes any type label corresponding to the requested news message; when the historical click record includes a type label corresponding to the requested news message, add one to a number of clicks on the type label corresponding to the news message in the historical click record; and when the historical click record does not include a type label corresponding to the requested news message, add the type label corresponding to the requested news message into the historical click record, and assign the number of the clicks on the type label as one.

When a user browses a news message using the method described above, in the historical click record of the user, the number of the clicks on each type label corresponding to the news message may be modified. As such, the historical click record is ensured to include the latest situation of news message browsing of the user, and subsequent selection of the activity information item using the historical click record may be more accurate. Therefore, the selected activity information item with the highest user preference value may match more precisely with the preference of the user.

In one embodiment, the news message and the activity information item are correlated through the type labels. According to the historical click record of a user, the news-message reading preference of the user in a recent period may be determined, the activity information item with the highest user preference value may be selected, and then the selected activity information item with the highest user preference value may be inserted into a news message list. As such, it may increase the interest and the diversity for the user in reading news messages, and improve the user's participation in the activity corresponding to the activity information item. In addition, the activity information items may also attract users to browse news messages every day, and the view counts of the news messages may be improved. In one embodiment, the recommendation of the activity information items may have a certain degree of real-time performance. When the user preference changes, the types of the recommended activity information item may change accordingly. In addition, the recommendation of the activity information item is based on the historical click record of the user, and does not need human intervention. Therefore, the recommendation of the activity information item is highly automatic, which saves labor costs. The more activity information items are included in the activity list, the more advantages may be demonstrated by the disclosed method for recommending activity information.

According to the present disclosure, an activity information item with the highest user preference value is selected from an activity list according to the historical click record; the selected activity information item is inserted into a news message list, and the news message list is sent to the client terminal. According to the present disclosure, the activity information item with the highest user preference value is selected, and the selected activity information item is inserted into the news message list. Therefore, the recommended activity information item is the information that the user is interested in, and the activity information item can also be displayed together with the news messages. When the user browses the news message list, the activity information item can also be viewed. Therefore, user's participation in the activity corresponding to the activity information item may be improved.

### Embodiment 2

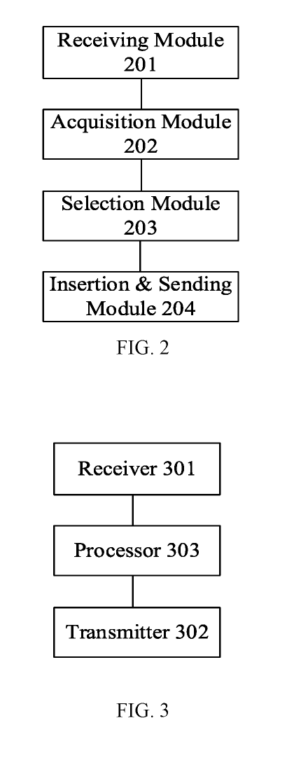

Referring to FIG. 2, the present disclosure provides an apparatus for recommending activity information. The apparatus may be configured to execute the method for recommending activity information provided in the aforementioned Embodiment 1. The functional modules of the apparatus for recommending activity information may be implemented by hardware, software, or a combination of hardware and software that can implement the principles of the present disclosure. Those skilled in the art should understand that the functional modules described in FIG. 2 may be combined together or divided into sub-modules to implement the principles of the present disclosure. Accordingly, the description herein may support any possible combination, or division, or further definition of the functional modules.

The apparatus for recommending activity information may include:

a receiving module 201, configured to receive a news message browsing request sent from a client terminal, the news message browsing request including a user ID and a webpage address;

an acquisition module 202, configured to acquire a news message list according to the webpage address and also acquire a historical click record of the user according to the user ID;

a selection module 203, configured to select an activity information item with the highest user preference value from an activity list according to the historical click record of the user obtained by the acquisition module 202; and

an insertion and sending module 204, configured to insert the activity information item selected by the selection module 203 into the news message list and send the news message list to the client terminal.

The selection module 203 may select the activity information item with the highest user preference value using a first determination unit, a calculation unit, and a selection unit.

The first determination unit may be configured to determine the type labels corresponding to each activity information item included in the activity list; the calculation unit may be configured to, according to the historical click record of the user and the type labels corresponding to each activity information item, calculate the user preference value for each activity information item respectively; and the selection unit may be configured to select the activity information item with the highest user preference value from the activity information items.

In one embodiment, the historical click record may include the type labels corresponding to the news messages clicked by the user in a preset time range and the number of the clicks on each type label. The calculation unit may calculate the user preference value of each activity information item using an acquisition sub-unit and a statistic sub-unit.

The acquisition sub-unit may be configured to acquire the number of the clicks on each type label corresponding to the activity information item in the historical click record; and the statistic sub-unit may be configured to count the number of the clicks on each type label corresponding to the activity information item for a sum value, and assign the counted sum value as the user preference value of the activity information item.

In one embodiment, a preset position for inserting the selected activity information item may be set in advance in the server. The preset position may be arranged on an upper side, a lower side, a left side, or a right side of the news message list, or may be the position of a news message that has a serial number in the news message list equal to a preset number. In this case, the insertion and sending module 204 may insert the activity information item into the news message list using a first insertion unit.

Moreover, because the news message list may include a plurality of news messages with different information contents, there may be a news message whose content is similar to the content of the selected activity information item. Since the user preference value of the selected activity information item is calculated based on the historical click record of the user in a past preset time range, the news message similar to the content of the selected activity information item may also be a news message that the user may be interested in. Therefore, the possibility for the user to browse the news message is very high. When the selected activity information item is inserted at a position of the similar news message, the user may be able to see the activity information item when browsing the news message, and may most likely participate in the activity corresponding to the activity information item. Therefore, in one embodiment, the insertion and sending module 204 may also insert the activity information item into the news message list using a second insertion unit.

The first insertion unit may be configured to insert the selected activity information item into a preset position of the news message list requested by the user; or

The second insertion unit may be configured to determine, from the news message list, a news message having a highest similarity value with the selected activity information item, and insert the activity information item into a position of the determined news message.

The second insertion unit may determine, from the news message list, the news message having the highest similarity value with the selected activity information item using a determination sub-unit and a selection sub-unit.

The determination sub-unit may be configured to determine type labels corresponding to each news message in the news message list respectively and determine the type labels corresponding to the selected activity information item; determine, among the type labels corresponding to each news message respectively, a number of type labels that are same as corresponding to the selected activity information item; and use the number of the type labels corresponding to each news message that are the same as corresponding to the selected activity information item respectively as a similarity value between each news message and the activity information item. The selection sub-unit may be configured to select the news message with the highest similarity value from the news messages.

In one embodiment, the insertion and sending module 204 may send a list of news messages including the inserted activity information item to the client terminal. The client terminal may receive the news message list, and may render and display the news page according to the new message list. The news page may include hyperlinks corresponding to a plurality of news messages and the activity information item recommended by the server. A user may browse the news page. When the user needs to read the detail content of a news message, the user may click on the hyperlink corresponding to the news message. When the client terminal detects the browsing instruction triggered by the hyperlink, a news message browsing request for browsing the news message may be sent to the server. The news message browsing request may include the user ID and the news-message ID. The news-message ID may be the webpage address or the news title corresponding to the news message. Accordingly, the apparatus may also modify the number of the clicks on the type label in the historical click record using a click-number modification module.

The click-number modification module may be configured to receive a news message browsing request from a user, the news message browsing request including the user ID and the news-message ID; acquire the historical click record of the user according to the user ID, and determine the type labels corresponding to the news messages according to the news-message ID; query whether the historical click record includes any type label corresponding to the requested news message; when the historical click record includes a type label corresponding to the requested news message, add one to a number of clicks on the type label corresponding to the news message in the historical click record; and when the historical click record does not include a type label corresponding to the requested news message, add the type label corresponding to the requested news message into the historical click record, and assign the number of the clicks on the type label as one.

A user may read news messages at various time ranges during a day. However, the times at which the user reads the news messages may be centralized in a certain time range of a day. For example, a user may be accustomed to reading the news during a specific time range in the morning or in the evening. When an activity information item is recommended to the user during the time range in which the user usually reads the news, the user may be more likely to browse the activity information item and thus participate in the activity. Therefore, in one embodiment, the centralized browsing time range of each user may be recorded using a memory module.

The memory module may be configured to, each time after receiving a news message browsing request send from a client terminal, record the receiving time of the news information browsing request of the user in a browsing time record of the user; determine the centralized browsing time range of the user according to the browsing time record of the user, and store the corresponding relation between the user ID and the centralized browsing time range of the user.

Further, the apparatus may determine whether the current time is in the centralized browsing time range of the user using a recommendation-time determination module.

The recommendation-time determination module may be configured to acquire a centralized browsing time range corresponding to the user according to the user ID, and determine whether the current time is in the centralized browsing time range of the user; when the current time is determined to be in the centralized browsing time range, perform an operation to acquire the historical click record of the user according to the user ID; when it is determined that the current time is not in the centralized browsing time range of the user, the news message list may be directly sent to the client terminal.

In one embodiment, although the type of news messages that the user prefers to read may change over time, for a short period of time such as two days or a week, the type of news messages that the user prefers may remain unchanged. Therefore, in a short period of time, a same or similar activity information item may be selected according to the historical click record of the user. For example, in two consecutive days, the selected activity information items with the highest user preference value may be a same activity information item. In this case, if the same activity information item is recommended to the user for two consecutive days, the probability of the user browsing the activity information item may be very low and the user experience may be poor.

In order to avoid the problem of recommending a same or similar activity information item, in one embodiment, the apparatus may store the corresponding relation between user IDs and issued activity queues, and each issued activity queue may include activity information items that have been recommended to the user. The apparatus may determine whether the selected activity information item is included in the issued activity queue using a duplicated activity information removal module described below.

The duplicated activity information removal module may be configured to acquire the issued activity queue corresponding to the user according to the user ID, and determine whether the issued activity queue includes an activity information item having a similarity value with the select the activity information item greater than a preset threshold value; when it is determined that no activity information item in the issued activity queue has a similarity value with the selected activity information item greater than the preset threshold value, insert the selected activity information item into the news message list; when the issued activity queue includes an activity information item having a similarity value with the selected activity information item greater than the preset threshold value, remove the selected activity information item from the activity list, and select an activity information item with the highest user preference value again from the revised activity list.

The duplicated activity information removal module may determine whether the issued activity queue includes an activity information item having a similarity value with the select the activity information item greater than a preset threshold value using a second determination unit, an acquisition unit, a third determination unit, and a comparison unit.

The second determination unit may be configured to determine the type labels corresponding to the selected activity information item, and determine the type labels corresponding to each activity information item in the issued activity queue. The acquisition unit may be configured to acquire, among the type labels corresponding to each activity information item in the issued activity queue, a number of the type labels that are same type labels corresponding to the selected activity information item. The third determination unit may be configured to use the number corresponding to each activity information item in the issued activity queue respectively as a similarity value between each activity information item and the selected activity information item. The comparison unit may be configured to compare the similarity value corresponding to each activity information item in the issued activity queue with the preset threshold value to determine whether the issued activity queue includes an activity information item having a similarity value with the select the activity information item greater than the preset threshold value.

After the insertion and sending module 204 inserts the finally selected activity information item into the news message list, the apparatus may add the activity information item to the issued activity queue of the user using an add module. The add module may be configured to use the current time as an issued time for the activity information item and add the issued time and the activity information item to the issued activity queue corresponding to the user.

Prior to the add module adding the activity information item into the issued activity queue corresponding to the user, the apparatus may determine whether the issued activity queue is full using a judgement module.

The judgement module may be configured to determine whether an issued activity queue is full, when the issued activity queue is not full, perform an operation to add the issued time and the activity information item into an issued activity queue corresponding to the user; when the issued activity queue is determined to be full, determine, from the issued activity queue, an activity information item with a largest time difference between the issued time and the current time, remove the determined activity information item from the issued activity queue, and perform the operation to add the issued time and the activity information item into the issued activity queue corresponding to the user.

In one embodiment, an activity list may be preset in the apparatus, and a large amount of news messages may be stored in the apparatus. The apparatus may determine the type labels corresponding to each activity information item in the activity list and also the type labels corresponding to each news message through a type label determination module.

The type label determination module may be configured to perform a semantic analysis on each activity information item included in the activity list to extract a preset number of keywords from each activity information item, and make the keywords corresponding to each activity information item as the type labels corresponding to the activity information item.

The type label determination module may also be used to form a label collection using the type labels corresponding to each activity information item, perform a semantic analysis on the news message to extract a plurality of keywords from the news message, query whether the label collection includes the extracted keywords, and when the label collection includes the extracted keywords, make the keywords included in the label collection as type labels corresponding to the news message.

According to the present disclosure, an activity information item with the highest user preference value is selected from an activity list according to the historical click record; the selected activity information item is inserted into a news message list, and the news message list is sent to the client terminal. According to the present disclosure, the activity information item with the highest user preference value is selected, and the selected activity information item is inserted into the news message list. Therefore, the recommended activity information item is the information that the user is interested in, and the activity information item can also be displayed together with the news messages. When the user browses the news message list, the activity information item can also be viewed. Therefore, user's participation in the activity corresponding to the activity information item may be improved.

### Embodiment 3

Referring to FIG. 3, the present disclosure provides a computing device. The computer device may be used to execute the method for recommending activity information as illustrated in the aforementioned Embodiment 1. The computing device may include a receiver 301, a transmitter 302, and a processor 303.

The receiver 301 may be configured to receive a browsing request for webpage information sent from a client terminal, the browsing request for the webpage information including a user ID and a webpage address.

The processor 303 may be configured to acquire a news message list according to the webpage address, and acquire a historical click record of the user according to the user ID; select an activity information item with a highest user preference value from an activity list according to the historical click record; and insert the selected activity information item into the news message list.

The transmitter 302 may be configured to send the news message list to the client terminal.

The processor 303 may be used to determine the type labels corresponding to each activity information item included in the activity list respectively; according to the historical click record and the type labels corresponding to the activity information item, calculate the user preference value of each activity information item respectively; and select an activity information item with the highest user preference value from the activity information items.

In one embodiment, the historical click record may include the type labels corresponding to the news messages clicked by the user in a preset time range and the number of the clicks on each type label. The processor 303 may be configured to acquire, from the historical click record, the number of the clicks on each type label corresponding to the activity information item; count the number of the clicks on each type label corresponding to the activity information item for a sum value, and assign the counted sum value as the user preference value of the activity information item.

In one embodiment, a preset position for inserting the selected activity information item may be set in advance in the server. The preset position may be arranged on an upper side, a lower side, a left side, or a right side of the news message list, or may be the position of a news message that has a serial number in the news message list equal to a preset number. In this case, the processor 202 may be used to insert the selected activity information item into the preset position of the news message list.

Moreover, because the news message list may include a plurality of news messages with different information contents, there may be a news message whose content is similar to the content of the selected activity information item. Since the user preference value of the selected activity information item is calculated based on the historical click record of the user in a past preset time range, the news message similar to the content of the selected activity information item may also be a news message that the user may be interested in. Therefore, the possibility for the user to browse the news message is very high. When the selected activity information item is inserted at a position of the similar news message, the user may be able to see the activity information item when browsing the news message, and may most likely participate in the activity corresponding to the activity information item. Therefore, in one embodiment, the processor 303 may also be used to determine, from the news message list, a news message having a highest similarity value with the selected activity information item, and insert the activity information item into a position of the determined news message.

When determining the news message having the highest similarity value with the selected activity information item from the news message list, the processor 303 may be used to determine type labels corresponding to each news message in the news message list respectively and determine the type labels corresponding to the selected activity information item; determine, among the type labels corresponding to each news message respectively, a number of type labels that are same as corresponding to the selected activity information item; use the number of the type labels corresponding to each news message that are the same as corresponding to the selected activity information item respectively as a similarity value between each news message and the activity information item; and select the news message with the highest similarity value from the news messages.

In one embodiment, after the transmitter 302 sends the news message list to the client terminal, the receiver 301 may also be used to receive a news message browsing request from the client terminal. The news message browsing request may include a user ID and a news-message ID.

The processor 303 may also be used to acquire the historical click record of the user according to the user ID and determine the type labels corresponding to the news message according to the news-message ID; query whether the historical click record includes any type label corresponding to the requested news message; when the historical click record includes a type label corresponding to the requested news message, add one to a number of clicks on the type label corresponding to the news message in the historical click record; and when the historical click record does not include a type label corresponding to the requested news message, add the type label corresponding to the requested news message into the historical click record, and assign the number of the clicks on the type label as one.

In one embodiment, prior to acquiring the historical click record of the user according to the user ID, the processor 303 may also be used to acquire the centralized browsing time range corresponding to the user, and determine whether the current time is in the centralized browsing time range of the user. When the current time is determined to be in the centralized browsing time range, the operation to acquire the historical click record of the user according to the user ID may be performed. When it is determined that the current time is not in the centralized browsing time range of the user, the acquired news message list may be directly sent to the client terminal using the transmitter 302.

In one embodiment, the computing device may also include a memory. Prior to acquiring the centralized browsing time range corresponding to the user according to the user ID, the processor 303 may also be used to record the receiving time of the news message browsing request in the browsing time record of the user each time when the receiver 301 receives a news message browsing request from a client terminal, and determine the centralized browsing time range of the user according to the browsing time record of the user.

The memory described above may be configured to store the corresponding relation between the user ID and the centralized browsing time range of the user.

Prior to inserting the selected activity information item into the news message list, the processor 303 may also be configured to acquire the issued activity queue corresponding to the user according to the user ID, and determine whether the issued activity queue includes an activity information item having a similarity value with the select the activity information item greater than a preset threshold value; when it is determined that no activity information item in the issued activity queue has a similarity value with the selected activity information item greater than the preset threshold value, insert the selected activity information item into the news message list; when the issued activity queue includes an activity information item having a similarity value with the selected activity information item greater than the preset threshold value, remove the selected activity information item from the activity list, and select an activity information item with the highest user preference value again from the revised activity list.

When determining whether the issued activity queue includes an activity information item having a similarity value with the selected activity information item greater than a preset threshold value, the processor 303 may be configured to determine the type labels corresponding to the selected activity information item, and determine the type labels corresponding to each activity information item in the issued activity queue; acquire, among the type labels corresponding to each activity information item in the issued activity queue, a number of the type labels that are same type labels corresponding to the selected activity information item; use the number corresponding to each activity information item in the issued activity queue respectively as a similarity value between each activity information item and the selected activity information item; and compare the similarity value corresponding to each activity information item in the issued activity queue with the preset threshold value to determine whether the issued activity queue includes an activity information item having a similarity value with the select the activity information item greater than the preset threshold value.

After inserting the selected activity information item into the news message list, the processor 303 may also be configured to use the current time as an issued time for the activity information item and add the issued time and the activity information item to the issued activity queue corresponding to the user.

Prior to adding the issued time and the activity information item into the issued activity queue corresponding to the user, the processor 303 may also be configured to determine whether an issued activity queue is full, when the issued activity queue is not full, perform an operation to add the issued time and the activity information item into an issued activity queue corresponding to the user; when the issued activity queue is determined to be full, determine, from the issued activity queue, an activity information item with a largest time difference between the issued time and the current time, remove the determined activity information item from the issued activity queue, and perform the operation to add the issued time and the activity information item into the issued activity queue corresponding to the user.

Prior to receiving the news message browsing request sent from a client terminal, the processor 303 may also be configured to perform a semantic analysis on each activity information item included in the activity list to extract a preset number of keywords from each activity information item, and make the keywords corresponding to each activity information item as the type labels corresponding to the activity information item.

After determining the keywords corresponding to each activity information item as the type labels corresponding to the activity information item respectively, the processor 303 may be configured to form a label collection using the type labels corresponding to each activity information item, perform a semantic analysis on the news message to extract a plurality of keywords from the news message, query whether the label collection includes the extracted keywords, and when the label collection includes the extracted keywords, make the keywords included in the label collection as type labels corresponding to the news message.

According to the present disclosure, an activity information item with the highest user preference value is selected from an activity list according to the historical click record; the selected activity information item is inserted into a news message list, and the news message list is sent to the client terminal. According to the present disclosure, the activity information item with the highest user preference value is selected, and the selected activity information item is inserted into the news message list. Therefore, the recommended activity information item is the information that the user is interested in, and the activity information item can also be displayed together with the news messages. When the user browses the news message list, the activity information item can also be viewed. Therefore, user's participation in the activity corresponding to the activity information item may be improved.

Moreover, the present disclosure also provides another computing device. The computing device may include a network interface, one or more processors, and a display. The network interface may be configured to allow the computing device to receive webpage information browsing requests through one or more networks. The one or more processors may be connected to the network interface, and configured to execute part or all of the steps of the above-mentioned method for recommending activity information. The display may be connected to the one or more processors, and configured to display the activity information item and the webpage information to the user. The computing device may be any appropriate device with computation function. For example, the computing device may be a personal computer (PC), a server, or a mobile terminal such as a cellphone.

The above technical idea of the present disclosure may also be implemented as a computing device including a processor and a non-transitory machine-readable storage medium. The non-transitory machine-readable storage medium may include pre-stored executable code.

When the executable code is executed by the processor, part or all of the steps of the disclosed method for recommending activity information described above may be implemented by the processor.

The apparatus for recommending activity information provided by various embodiments of the present disclosure may be specific hardware on a device, software or firmware installed on the device, or any other appropriate device. Those skilled in the art may clearly understand that, for the convenience and simplicity of the illustration, the specific operation process of the disclosed modules, devices, and units may refer to the corresponding process described in the above method embodiments.

From various embodiments provided in the present disclosure, it should be understood that the disclosed apparatuses and methods may be implemented in other ways. Therefore, the apparatus embodiments described above are merely exemplary. For example, the division of the units is merely based on the logical functions, and in practical implementation, other division methods may be adopted. For another example, multiple units or components may be combined or integrated into another system, or some features can be ignored or not executed.

In addition, the illustrated or discussed mutual coupling may be direct coupling or communication connection achieved through some communication interfaces; the indirect coupling or communication connection between devices or units may be electrical, mechanical, or any other appropriate form.

The units described as separate components may or may not be physically separated. The components displayed as units may or may not be physical units, that is, may be located in one place or may be distributed to multiple units in a network. Some or all of the units may be selected according to actual needs to achieve the purposes of the present disclosure.

In addition, each functional unit in the embodiments of the present disclosure may be integrated in one processing unit. Alternatively, each unit may be physically separated from each other or two or more units may be integrated in one unit.

When the functions are implemented in the form of software functional units and are sold or used as separate products, the functions may be stored in a computer-readable storage medium. Based on this understanding, the part of the technical solution according to the present disclosure that essentially contributes to the prior art, or the part of the technical solution may be embodied in the form of a software product. The software product may be stored in a storage medium, and may include a plurality of instructions used to enable a computer device (such as a personal computer, a server, a network device, etc.) to execute all or part of the steps of the method according to various embodiments of the present disclosure. The above-mentioned storage medium may include various media capable of storing program code such as a USB flash disk, a removable hard disk, a read-only memory (ROM), a random access memory (RAM), a magnetic disk, or an optical disk.

The above descriptions are merely some embodiments of the present invention and are not intended to limit the scope of the present invention. Within the technical scope disclosed in the present disclosure, all changes and substitutions that those skilled in the art may easily conceive should be covered by the protection scope of the present invention. Therefore, the protection scope of the present invention should be subject to the protection scope of the claims.

1. A method for recommending activity information implemented by a hardware processor, comprising:
selecting an activity information item with a highest user preference value from an activity list according to a historical click record of a user for browsing webpage information, wherein webpage information browsing includes news message browsing; and
sending the selected activity information item and webpage information correlatively to the user.

2. The method according to claim 1, wherein selecting the activity information item with the highest user preference value from the activity list according to the historical click record of the user for browsing webpage information includes:
determining type labels corresponding to each activity information item in the activity list;
according to the historical click record of the user and the type labels corresponding to each activity information item, calculating the user preference value for each activity information item respectively; and
selecting the activity information item with the highest user preference value from the activity information items.

3. The method according to claim 2, wherein the historical click record includes type labels corresponding to news messages clicked by the user in a past preset time range and a number of clicks on each type label; and
according to the historical click record of the user and the type labels corresponding to each activity information item, calculating the user preference value for each activity information item respectively includes:
acquiring the number of the clicks on each type label corresponding to the activity information item in the historical click record; and
counting the number of the clicks on each type label corresponding to the activity information item for a sum value, and assigning the counted sum value as the user preference value of the activity information item.

4. The method according to claim 1, wherein sending the selected activity information item and the webpage information correlatively to the user includes:
inserting the selected activity information item into a preset position of a news message list requested by the user; or
determining, from the news message list, a news message having a highest similarity value with the selected activity information item, and inserting the activity information item into a position of the determined news message.

5. The method according to claim 4, wherein determining, from the news message list, the news message having the highest similarity value with the selected activity information item includes:
determining type labels corresponding to each news message in the news message list respectively and determining the type labels corresponding to the selected activity information item; and
determining, among the type labels corresponding to each news message respectively, a number of type labels that are same as corresponding to the selected activity information item;
using the number of the type labels corresponding to each news message that are the same as corresponding to the selected activity information item as a similarity value between each news message and the activity information item; and
selecting the news message with the highest similarity value from the news messages.

6. The method according to claim 1, further including:
in response to a browsing request from a user for a news message, updating the historical click record of the user,
wherein updating the historical click record of the user includes:
determining type labels corresponding to the requested news message;
querying whether the historical click record includes any type label corresponding to the requested news message;
when the historical click record includes a type label corresponding to the requested news message, adding one to a number of clicks on the type label corresponding to the news message in the historical click record; and
when the historical click record does not include a type label corresponding to the requested news message, adding the type label corresponding to the requested news message into the historical click record, and assigning the number of the clicks on the type label as one.

7. The method according to claim 1, further including:
acquiring a centralized browsing time range corresponding to the user; and
when a current time is determined to be in the centralized browsing time range, performing an operation for selecting the activity information item with the highest user preference value from the activity list.

8. The method according to claim 7, wherein acquiring the centralized browsing time range corresponding to the user includes:
recording a time of receiving a browsing request from the user for the webpage information as a browsing time record of the user; and
determining the centralized browsing time range of the user according to the browsing time record of the user.

9. The method according to claim 1, wherein selecting the activity information item with the highest user preference value from the activity list further includes:
acquiring an issued activity queue corresponding to the user; and
selecting, from the activity list, the activity information item having a similarity value with each activity information item in the issued activity queue less than or equal to a preset threshold value and having the highest user preference value.

10. The method according to claim 9, wherein selecting, from the activity list, the activity information item having the similarity value with each activity information item in the issued activity queue less than or equal to the preset threshold value and having the highest user preference value includes:
acquiring, among the type labels corresponding to each activity information item in the issued activity queue, a number of the type labels that are same type labels corresponding to the selected activity information item in the activity list as a similarity value.

11. The method according to claim 9, further including:
in response to sending the selected activity information item and the webpage information correlatively to the user, adding an issued time of the activity information item and the activity information item into the issued activity queue corresponding to the user.

12. The method according to claim 11, prior to adding the issued time and the activity information item into the issued activity queue corresponding to the user, further including:
determining whether the issued activity queue is full, when the issued activity queue is not full, performing an operation to add the issued time and the activity information item into the issued activity queue corresponding to the user; and
when the issued activity queue is determined to be full, from the issued activity queue, determining an activity information item with a largest time difference between the issued time and the current time, removing the determined activity information item from the issued activity queue, and performing the operation to add the issued time and the activity information item into the issued activity queue corresponding to the user.

13. The method according to claim 1, further including:
performing a semantic analysis on each activity information item included in the activity list to extract a preset number of keywords from each activity information item, and making the keywords corresponding to each activity information item as type labels corresponding to the activity information item.

14. The method according to claim 13, wherein making the keywords corresponding to each activity information item as the type labels corresponding to the activity information item further includes:
forming a label collection using the type labels corresponding to each activity information item; and
performing a semantic analysis on a news message to extract a plurality of keywords from the news message, querying whether the label collection includes the extracted keywords, and when the label collection includes the extracted keywords, making the keywords included in the label collection as type labels corresponding to the news message.

15. A computing device, comprising:
a memory, configured to store instructions to implement a method for recommending activity information;
a processor, coupled with the memory, and, when executing the instructions, configured to:
select an activity information item with a highest user preference value from an activity list according to a historical click record of a user for browsing webpage information, wherein webpage information browsing includes news message browsing; and
send the selected activity information item and webpage information correlatively to the user.

16. The device according to claim 15, wherein the processor is further configured to:
determine type labels corresponding to each activity information item included in the activity list;
according to the historical click record of the user and the type labels corresponding to each activity information item, calculate the user preference value for each activity information item respectively; and
select the activity information item with the highest user preference value from the activity information items.

17. (canceled)

18. The device according to claim 15, wherein the processor is further configured to:
insert the selected activity information item into a preset position of the news message list requested by the user; or
determine, from the news message list, a news message having a highest similarity value with the selected activity information item, and insert the activity information item into a position of the determined news message.

19.-28. (canceled)

29. The device according to claim 15, further comprising:
a receiver and a transmitter, wherein:
the receiver, is configured to receive a browsing request for the webpage information sent from a client terminal, the browsing request for the webpage information including a user ID and a webpage address, wherein, the webpage information includes news messages;
the processor, is configured to acquire a news message list according to the webpage address, and acquire the historical click record of the user according to the user ID; select the activity information item with the highest user preference value from the activity list according to the historical click record; and insert the selected activity information item into the news message list; and
the transmitter, is configured to send the news message list to the client terminal.

30. The device according to claim 15, further comprising:
a network interface and a display, wherein:
the network interface allows the computing device to communicate a browsing request from the user for the webpage information through one or more networks; and
the processor is connected with the network interface; and
the display is connected to the processor, and configured to display the activity information item and the webpage information to the user.

31. A non-transitory machine-readable storage medium, containing pre-stored executable code, wherein when the executable code is executed by a processor, the processor implements a method for recommending activity information, the method comprising:
selecting an activity information item with a highest user preference value from an activity list according to a historical click record of a user for browsing webpage information, wherein webpage information browsing includes news message browsing; and
sending the selected activity information item and webpage information correlatively to the user.
